(19) United States
(12) Patent Application Publication
(10) Pub. No.: US 2025/0250954 A1
(43) Pub. Date: Aug. 7, 2025

(54) INTAKE NOISE AMPLIFYING SYSTEM OF INTERNAL COMBUSTION ENGINE

(71) Applicant: Mazda Motor Corporation, Aki-gun (JP)

(72) Inventors: Keisuke AGUSA, Aki-gun (JP); Yuta TAKAMURA, Aki-gun (JP); Shin KODAMA, Aki-gun (JP); Kazuki ONISHI, Aki-gun (JP)

(21) Appl. No.: 19/014,847

(22) Filed: Jan. 9, 2025

(30) Foreign Application Priority Data
Feb. 6, 2024 (JP) 2024-016459

(51) Int. Cl. F02M 35/12

(52) U.S. Cl. CPC F02M 35/1294; F02M 35/1255

(57) ABSTRACT

An intake noise amplifying system of an internal combustion engine of a vehicle is provided to a branch pipe branching from an intake passage of the engine and transmitting intake noise into a cabin of the vehicle. The system includes a plate-shaped vibration body which vibrates by intake pulse from the intake passage, a first case disposed in the branch pipe on an intake passage side of the vibration body, and a second case disposed in the branch pipe on a cabin side of the vibration body. The vibration body is sandwiched between the first and second cases. One of the first and second cases includes a grid plate having a grid dividing the vibration body into partitioned parts, and the other includes a bore plate having bores each having an area smaller than a minimum area of the partitioned parts.

### TECHNICAL FIELD

The art disclosed herein belongs to a technical field about an intake noise amplifying system of an internal combustion engine.

### BACKGROUND OF THE DISCLOSURE

Conventionally, structures for transmitting intake noise occurring in an intake passage of an internal combustion engine to the exterior of an engine compartment, such as the inside of a cabin, are known.

For example, JP6216527B2 discloses an intake noise introduction device provided with a branch path which branches from the intake passage of the internal combustion engine, a sound creator, and a transmission path. The sound creator is provided with an introducing pipe which is connected to a cabin-side end part of the branch path and communicates with this branch path, a vibration body which is provided to a cabin-side end part of this introducing pipe and vibrates by intake pulse of intake noise which is transmitted inside the branch path and the introducing pipe, and a case which surrounds the introducing pipe so that a space is formed between the introducing pipe and this case. The transmission path communicates with the case of the sound creator and transmits the vibration of the vibration body into the cabin. The intake noise introduction device disclosed in JP6216527B2 amplifies vibration at a specific frequency among sound vibrations of which the sound source is the vibration of the vibration body, by the air column resonance of the case, and transmits it into the cabin.

As for the purpose of transmitting the intake noise into the cabin, it produces a sporty effect to improve the feel for a vehicle driver, and provides feedback for the driver's operation of the vehicle. Since the frequency of the intake pulse varies according to the engine speed, the intake noise needs to be amplified, especially from the viewpoint of providing feedback, within a wide range from a low frequency to a high frequency.

### SUMMARY OF THE DISCLOSURE

Therefore, the art disclosed herein is made in view of this situation, and one purpose thereof is to expand a frequency range for amplifying intake noise in an intake noise amplifying system.

In order to achieve the above-described purpose, the first aspect of the art disclosed herein provides an intake noise amplifying system of an internal combustion engine mounted on a vehicle, the intake noise amplifying system being provided to a branch pipe that branches from an intake passage of the internal combustion engine and transmits intake noise into a cabin of the vehicle. The intake noise amplifying system includes a plate-shaped vibration body which vibrates by intake pulse from the intake passage, a first case disposed at a part of the branch pipe on an intake passage side of the vibration body, and a second case disposed at a part of the branch pipe on a cabin side of the vibration body. The vibration body is sandwiched between the first case and the second case. One of the first case and the second case includes a grid plate having a grid dividing the vibration body into a plurality of partitioned parts when the vibration body is seen in a direction perpendicular to the grid surface. The other of the first case and the second case includes a bore plate having a plurality of bores each having an area smaller than a minimum area of the partitioned parts when the vibration body is seen in the direction perpendicular to the grid surface.

According to the first aspect, an intake pulse of the intake noise is generated in the intake passage at a frequency according to the engine speed. The intake pulse is transmitted to the vibration body by the branch pipe. The vibration body vibrates due to the intake pulse. A part of the vibration body divided by the grid plate resonates with the intake pulse within a low frequency range where the frequency is comparatively low to amplify the intake noise within the low frequency range. On the other hand, a part of the vibration body located in the bore resonates with the intake pulse within a high frequency range where the frequency is comparatively high to amplify the intake noise within the high frequency range. Therefore, the frequency range over which the intake noise is amplified can be expanded.

According to the second aspect, in the intake noise amplifying system of the first aspect, the grid plate may be provided to the first case, and the bore plate may be provided to the second case.

According to the second aspect, since the partitioned area of the grid plate is larger than the area of the bore, the grid plate is located relatively upstream, and thus, sound waves of the low frequency range directly act on the entirety of the parts divided by the grid plate of the vibration body. Therefore, the intake noise within the low frequency range can be amplified efficiently.

According to the third aspect, in the intake noise amplifying system of the first aspect, a number of bores of the bore plate may be greater than a number of partitions of the grid plate.

According to the third aspect, even when the area of each bore is small, the intake noise within the high frequency range can be amplified appropriately by using the plurality of bores to resonate.

According to the fourth aspect, in the intake noise amplifying system of the first aspect, the partitioned parts may include a first partitioned part having a relatively large area, and a second partitioned part having a relatively small area. The area of the bores may be smaller than the area of the second partitioned part.

According to the fourth aspect, the area of the second partitioned part has the size in between the area of the first partitioned part and the area of the bore. Therefore, intake noise of a middle frequency range can be amplified using the second partitioned part. Therefore, the frequency range over which the intake noise is amplified can be expanded.

According to the fifth aspect, in the intake noise amplifying system of any of the first to fourth aspects, the vibration body may be made of rubber.

According to the fifth aspect, if the vibration body is made of rubber, it becomes easy to vibrate only the parts divided by the grid plate, and/or to vibrate only the parts where the bores are located. Further, the resonant frequency may be adjusted easily by changing the hardness of the vibration body. Therefore, the frequency range over which the intake noise is amplified can be expanded.

### BRIEF DESCRIPTION OF DRAWINGS

FIG. 1 is a schematic view of an intake system of an internal combustion engine having an intake noise amplifying system according to one embodiment of the present disclosure.

FIG. 2 is a plan view illustrating a branch pipe.

FIG. 3 is a cross-sectional perspective view taken along a line III-III of FIG. 1.

FIG. 4 is a front view of the intake noise amplifying system from upstream of an intake passage.

FIG. 5 is a cross-sectional view taken along a line V-V of FIG. 3.

FIG. 6 is a front view illustrating an area which resonates at a low frequency.

FIG. 7 is a front view illustrating an area which resonates at a middle frequency.

FIG. 8 is a front view illustrating an area which resonates at a high frequency.

FIG. 9 is a graph illustrating a relationship between an engine speed and a noise volume of this embodiment and the conventional art.

FIG. 10 is a front view illustrating Modification 1 of the intake noise amplifying system.

FIG. 11 is a front view illustrating Modification 2 of the intake noise amplifying system.

### DETAILED DESCRIPTION OF THE DISCLOSURE

Hereinafter, an illustrative embodiment is described in detail with reference to the accompanying drawings.

### (Overall Configuration of Branch Pipe)

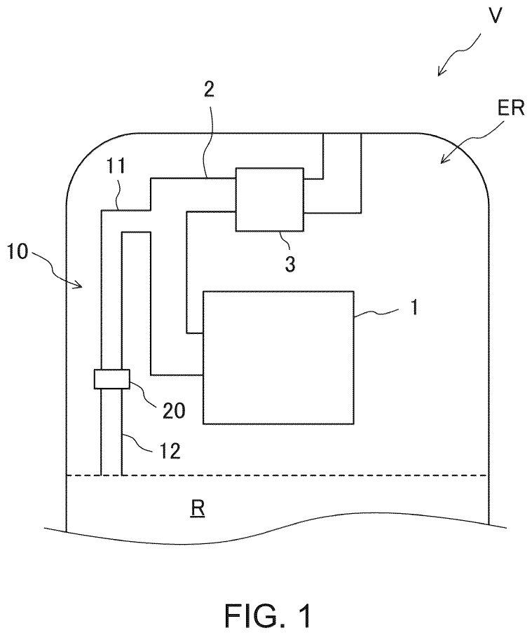

FIG. 1 schematically illustrates an intake system of an internal combustion engine 1. The internal combustion engine 1 is disposed inside an engine compartment ER of a vehicle V. An intake passage 2 for introducing intake air is connected to the internal combustion engine 1. The intake passage 2 includes an air cleaner 3. Intake air purified by the air cleaner 3 is introduced into the internal combustion engine 1.

A branch pipe 10 branches from the intake passage 2 downstream of the air cleaner 3. The branch pipe 10 is a part for introducing intake pulse of intake noise into a cabin R. The branch pipe 10 is disposed inside the engine compartment ER, along with the intake passage 2.

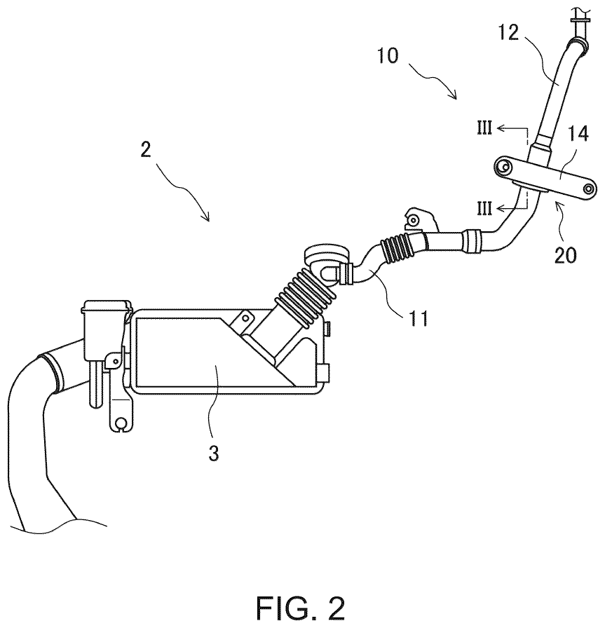

As illustrated in FIG. 2, the branch pipe 10 has an inlet pipe 11 connected to the intake passage 2, an outlet pipe 12 which communicates with the inside of the cabin R, and an intake noise amplifying system 20 which is located between the inlet pipe 11 and the outlet pipe 12, and amplifies the intake noise. A bracket 14 for fixing the branch pipe 10 to the vehicle body is provided at a position of the intake noise amplifying system 20.

The inlet pipe 11 is connected to an upper part of the intake passage 2. Thus, the intake pulse can be transmitted, with almost no escape of intake air passing through the intake passage 2 to the branch pipe 10. Since the intake air will be intercepted by the intake noise amplifying system 20 even if the intake air flows into the branch passage 10, the intake air passing through the intake passage 2 will not be directly introduced into the cabin R.

The outlet pipe 12 communicates with an area of the cabin R on the driver's seat side.

### (Intake Noise Amplifying System)

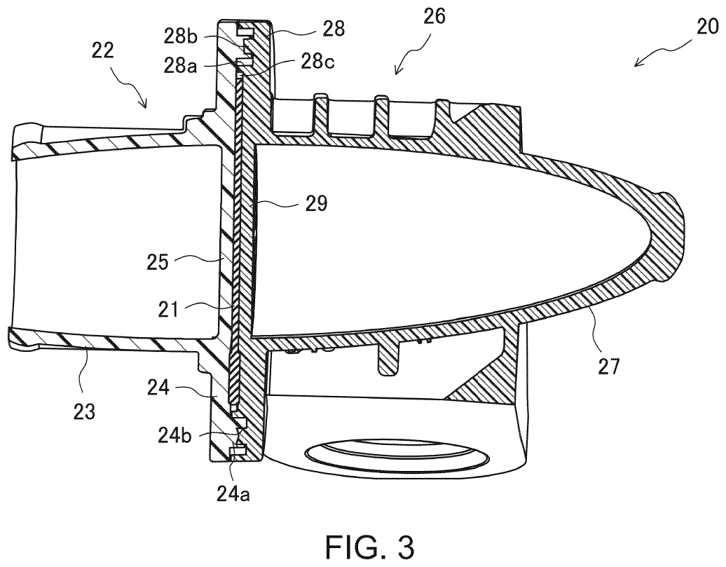

The intake noise amplifying system 20 is a device for amplifying the intake noise and transmitting the amplified intake noise into the cabin R. The intake noise amplifying system 20 causes a vibration body 21 (described later) to vibrate by resonance with greater amplitude to amplify the intake noise. Below, the intake noise amplifying system 20 is described with reference to FIGS. 3 to 8.

As illustrated in FIG. 3, the intake noise amplifying system 20 has the vibration body 21 which vibrates by the intake pulse of the intake noise, a first case 22 disposed on the inlet pipe 11 side of the vibration body 21, and a second case 26 disposed on the outlet-pipe 12 side of the vibration body 21. The first case 22 and the second case 26 are fixed so that they are not relatively displaced.

The vibration body 21 is made of rubber and has a disk shape. The hardness and thickness of the vibration body 21 are not limited in particular, but they may be changed according to the kind of vehicle V. The outer diameter of the vibration body 21 is larger than the outer diameter of a first body part 23 (described later) of the first case 22 and the outer diameter of a second body part 27 (described later) of the second case 26.

The first case 22 has the first body part 23, a first flange part 24 provided to a downstream end part of the first body part 23, and a grid plate 25 provided to the downstream end part inside the first body part 23. The first case 22 is made of resin.

The first body part 23 has a tube or pipe shape. The first body part 23 is disposed at a downstream end part inside the inlet pipe 11.

The first flange part 24 extends radially outward from the first body part 23 and spreads entirely in the circumferential direction. The first flange part 24 has a protrusion 24a which protrudes downstream. The protrusion 24a extends continuously and entirely in the circumferential direction of the first flange part 24. That is, the protrusion 24a has an annular shape in the tube-axis direction of the first case 22. A recess 24b which dents upstream is formed at the center of the protrusion 24a in the width direction. The recess 24b extends along the protrusion 24a, and extends continuously and entirely in the circumferential direction of the first flange part 24.

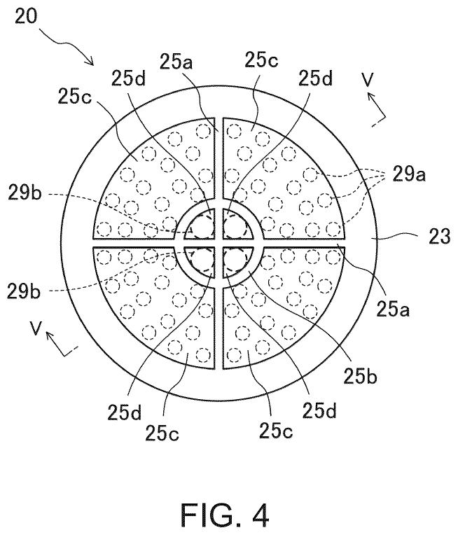

As illustrated in FIG. 4, the grid plate 25 has a pair of first grids 25a which extends straight in the radial direction and divides the inside of the first body part 23 into four, and an annular second grid 25b centering on the tube axis of the first body part 23. The first grid 25a is integrally formed with the first body part 23. The second grid 25b is integrally formed with the first grid 25a. The outer diameter of the second grid 25b is about ⅓ of the inner diameter of the first body part 23.

The grid plate 25 has four first partitioned parts 25c located inside the first body part 23 and outside the second grid 25b. Each first partitioned part 25c has a quadrant fan shape. Further, the grid plate 25 has four second partitioned parts 25d located inside the second grid 25b, and each second partitioned part 25d has a quadrant fan shape. The first partitioned parts 25c are located radially outward from the second partitioned parts 25d. The area of each first partitioned part 25c is larger than the area of each second partitioned part 25d. The areas of the four first partitioned parts 25c are the same. Similarly, the areas of the four second partitioned parts 25d are the same.

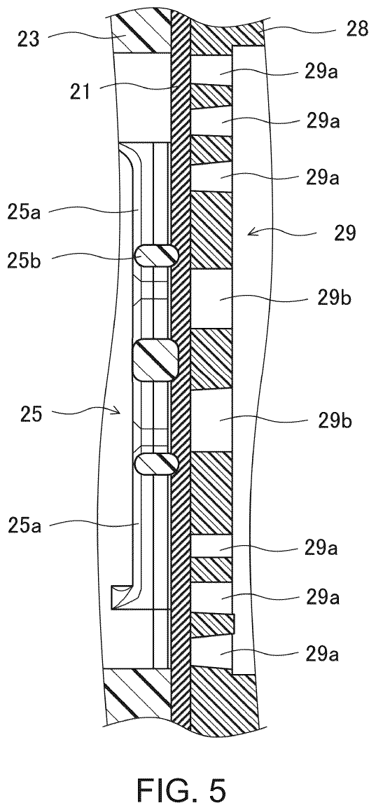

As illustrated in FIG. 5, the first body part 23, the first grid 25a, and the second grid 25b are embedded in the vibration body 21.

As illustrated in FIG. 3, the second case 26 has a second body part 27, a second flange part 28 provided to a downstream end part of the second body part 27, and a bore plate 29 provided to the downstream end part inside the second body part 27. The second case 26 is made of resin.

The second body part 27 has a tube or pipe shape. The second body part 27 is fixed to an upstream end part of the outlet pipe 12. The bracket 14 described above is provided to the second body part 27.

The second flange part 28 extends radially outward from the second body part 27 and spreads entirely in the circumferential direction. The second flange part 28 has a groove 28a with which the protrusion 24a of the first flange part 24 engages. The groove 28a extends continuously and entirely in the circumferential direction of the second flange part 28. That is, the groove 28a has an annular shape in the tube-axis direction of the second case 26. A protrusion 28b which protrudes upstream is provided at the center of the groove 28a in the width direction. The protrusion 28b extends along the groove 28a, and extends continuously and entirely in the circumferential direction of the second flange part 28. The protrusion 28b engages with the recess 24b of the first flange part 24.

The second flange part 28 has an accommodating part 28c which accommodates the vibration body 21.

As illustrated in FIG. 4, the bore plate 29 has a plurality of small bores 29a which have a relatively small diameter, and a large bore 29b which has a relatively large diameter.

The plurality of small bores 29a are formed in locations corresponding to the first partitioned parts 25c. The area of each small bore 29a is smaller than the area of the second partitioned part 25d. The small bores 29a of the first partitioned parts 25c are disposed in a layout of a rotational symmetry centering on the tube axis of the first case 22, when seen in the tube axis of the first case 22. The small bores 29a are not disposed at positions corresponding to the first grid 25a and the second grid 25b. Note that the layout of the small bores 29a in the first partitioned parts 25c may not be a rotational symmetry centering on the tube axis of the first case 22.

The large bore 29b is provided to an area corresponding to the second partitioned part 25d. Four large bores 29b are formed corresponding to the four second partitioned parts 25d. The area of each large bore 29b is smaller than the area of the second partitioned part 25d. The large bores 29b are not disposed at positions corresponding to the first grid 25a and the second grid 25b.

As illustrated in FIG. 5, an upstream surface of the bore plate 29 closely contacts the vibration body 21, without being embedded in the vibration body 21.

When the intake pulse of the intake noise from the inlet pipe 11 is transmitted to the vibration body 21, it vibrates. Therefore, sound is generated from the vibration of the vibration body 21. The sound is amplified when the vibration body 21 vibrates by resonance with greater amplitude.

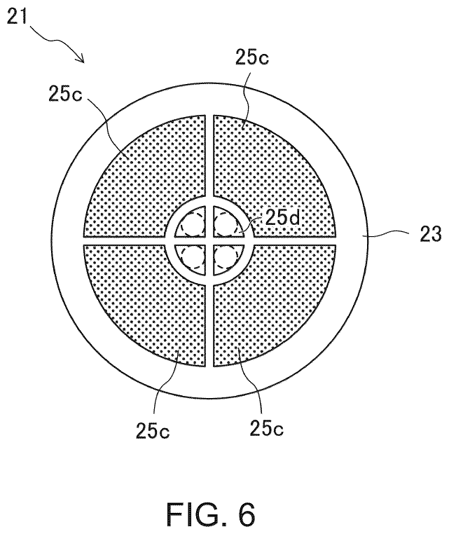

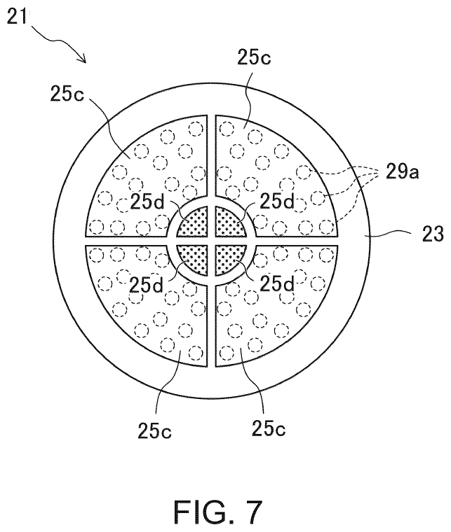

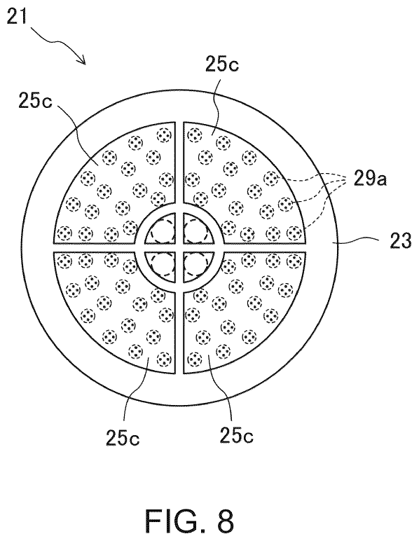

FIGS. 6 to 8 illustrate a part of the vibration body 21 which resonates with the intake pulse of each frequency range. FIG. 6 illustrates the part which resonates with the intake pulse at a low frequency, FIG. 7 illustrates the part which resonates with the intake pulse at a middle frequency, and FIG. 8 illustrates the part which resonates with the intake pulse at a high frequency. Here, the low frequency, the middle frequency, and the high frequency refer to a low frequency, a middle frequency, and a high frequency when a frequency range to be amplified is equally divided into three.

As illustrated in FIG. 6, the part of the vibration body 21 located in the first partitioned part 25c (hereinafter, referred to as “the first part”) resonates with the intake pulse at the low frequency. Each of the four first parts of the vibration body 21 resonates and vibrates. The sound created by the resonant vibration escapes from the small bore 29a, and is transmitted to the outlet pipe 12 and is then transmitted into the cabin R.

As illustrated in FIG. 7, the part of the vibration body 21 located in the second partitioned part 25d (hereinafter, referred to as “the second part”) resonates with the intake pulse at the middle frequency. Each of the four second parts of the vibration body 21 resonates and vibrates. The sound created by the resonant vibration escapes from the large bore 29b, and is transmitted to the outlet pipe 12 and is then transmitted into the cabin R.

As illustrated in FIG. 8, the part of the vibration body 21 located in the small bore 29a (hereinafter, referred to as “the third part”) resonates with the intake pulse at the high frequency. Each of the third parts of the vibration body 21 resonates and vibrates. The sound created by the resonant vibration is transmitted to the outlet pipe 12 and is then transmitted into the cabin R.

In this way, the part of the vibration body 21 corresponding to each of the frequencies vibrates by resonance to amplify the intake noise. The area of the second partitioned part 25d is set so that the resonant frequency of the second part of the vibration body 21 does not become an integral multiple of the resonant frequency of the first part of the vibration body 21. Further, the area of the small bore 29a is set so that the resonant frequency of the third part of the vibration body 21 does not become an integral multiple of the resonant frequencies of the first part and the second part of the vibration body 21.

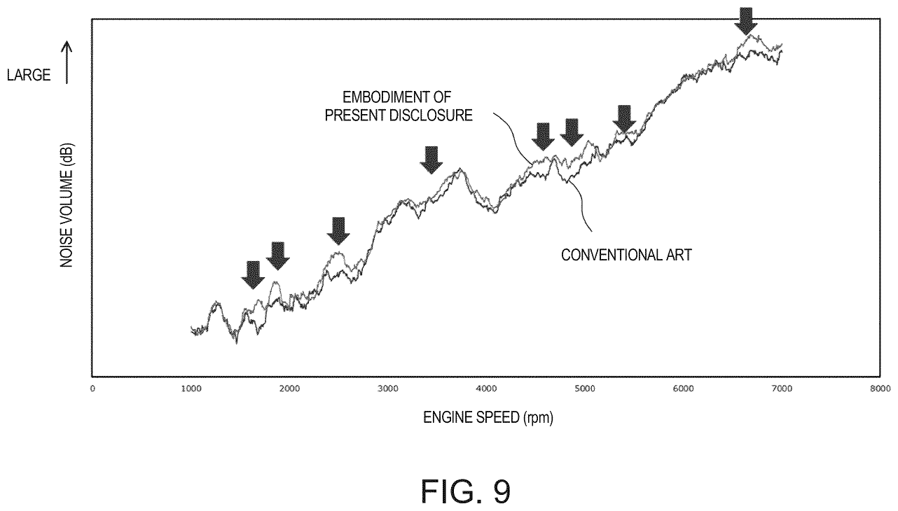

FIG. 9 illustrates the result of comparing the noise volume when the intake noise amplifying system 20 according to this embodiment is used with the noise volume when the conventional intake noise amplifying system is used. Note that the horizontal axis is an engine speed of the internal combustion engine. Generally, the frequency of the intake pulse of the intake noise is higher as the engine speed becomes higher. Both the intake noise amplifying systems amplify the intake noise of the frequency according to the engine speed. Arrows in the drawing indicate parts where the amplification effect on the intake noise by the intake noise amplifying system 20 according to this embodiment is notable.

As illustrated in FIG. 9, when the intake noise amplifying system 20 according to this embodiment was used, the noise volume became larger than that of the conventional intake noise amplifying system overall, from a low-speed range to a high-speed range. It can be seen that there are parts where the noise volume became notably larger across a wide range from the low-speed range to the high-speed range. Therefore, the frequency range over which the intake noise is amplified can be expanded by the intake noise amplifying system 20 according to this embodiment.

### Effects of Embodiment

As described above, in this embodiment, the vibration body 21 is sandwiched between the first case 22 and the second case 26. The first case 22 includes the grid plate 25 having the grid plates 25a and 25b which divide the vibration body 21 into the plurality of partitioned parts when seen in a direction perpendicular to the grid surfaces of the vibration body 21. The second case 26 includes the bore plate 29 having the plurality of small bores 29a having the area smaller than the minimum area divided by the grid plate 25 when seen in the direction perpendicular to the grid surface of the vibration body 21. The part divided by the grid plate 25 of the vibration body 21 resonates with the intake pulse of the low frequency range where the frequency is comparatively low to amplify the intake noise of the low frequency range. On the other hand, the part of the vibration body 21 located in the small bore 29a resonates with the intake pulse of the high frequency range where the frequency is comparatively high to amplify the intake noise of the high frequency range. Therefore, the frequency range over which the intake noise is amplified can be expanded.

Further, since the grid plate 25 is located relatively upstream, the sound wave of the low frequency range directly acts on the entirety of the parts divided by the grid plate 25 of the vibration body 21. Therefore, the intake noise of the low frequency range can be amplified efficiently.

In this embodiment, the number of small bores 29a of the bore plate 29 is more than the number of partitions of the grid plate 25. Therefore, even when the area of each small bore 29a is small, the intake noise of the high frequency range can be amplified appropriately by using the plurality of small bores 29a to resonate.

In this embodiment, the grid plate 25 has the first partitioned parts 25c which have the relatively large area, and the second partitioned parts 25d which have the relatively small area. The area of the small bore 29a is smaller than the area of the second partitioned part 25d. The area of the second partitioned part 25d has the size in between the area of the first partitioned part 25c and the area of the small bore 29a. Therefore, the intake noise of the middle frequency range can be amplified using the second partitioned parts 25d. Therefore, the frequency range over which the intake noise is amplified can be expanded.

In this embodiment, the area of the second partitioned part 25d is set so that the resonant frequency of the part corresponding to the second partitioned part 25d of the vibration body 21 does not become the integral multiple of the resonant frequency of the part corresponding to the first partitioned part 25c of the vibration body 21. The area of the small bore 29a is set so that the resonant frequency of the part corresponding to the small bore 29a of the vibration body 21 does not become the integral multiple of the resonant frequencies of the parts corresponding to the first partitioned part 25c and the second partitioned parts 25d of the vibration body 21. Therefore, since the number of frequencies at which the resonance of the intake noise amplifying system 20 is possible can be set to as many as possible, the frequency range over which the intake noise is amplified can be expanded.

In this embodiment, the second case 26 has the bracket 14 for fixing the branch pipe 10 to the vehicle body. Therefore, since the position of the intake noise amplifying system 20 can be stabilized, the first case 22 and the second case 26 can be suppressed from relatively displacing to change the resonant frequency, thereby reducing the amplification effect on the intake noise.

In this embodiment, the vibration body is made of rubber. If the vibration body 21 is made of rubber, it becomes easy to vibrate only the parts divided by the grid plate 25, and/or to vibrate only the parts where the small bores 29a are located. Further, the resonant frequency may be easily adjusted by changing the hardness of the vibration body. Therefore, the frequency range over which the intake noise is amplified can be expanded.

### Modification 1

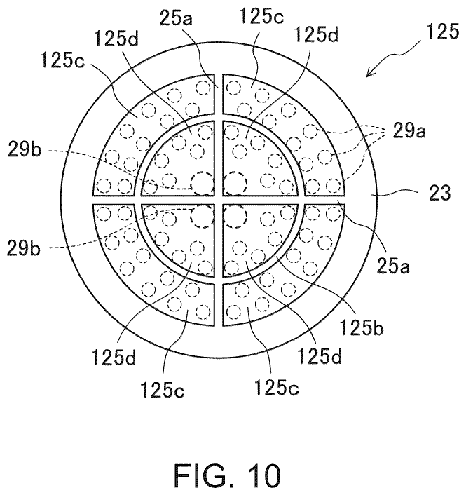

FIG. 10 illustrates Modification 1 of this embodiment. In Modification 1, the shape of a second grid 125b of a grid plate 125 differs from the above embodiment. In detail, the second grid 125b of Modification 1 is larger in diameter than the second grid 25b in the above embodiment. Therefore, the area of a first partitioned part 125c of Modification 1 is smaller than the area of the first partitioned part 25c in the above embodiment, and the area of a second partitioned part 125d of Modification 1 is larger than the area of the second partitioned part 25d in the above embodiment.

The area of the second partitioned part 125d is set so that the resonant frequency of the part of the vibration body 21 corresponding to the second partitioned part 125d does not become an integral multiple of the resonant frequency of the part of the vibration body 21 corresponding to the first partitioned part 125c. The area of the small bore 29a is set so that the resonant frequency of the part of the vibration body 21 corresponding to the small bore 29a does not become an integral multiple of the resonant frequencies of the parts of the vibration body 21 corresponding to the first partitioned part 125c and the second partitioned part 125d.

Also in this Modification 1, the intake noise is amplified by the vibration body 21 vibrating by resonance with the intake pulse from the low frequency to the high frequency. Therefore, the frequency range over which the intake noise is amplified can be expanded.

### Modification 2

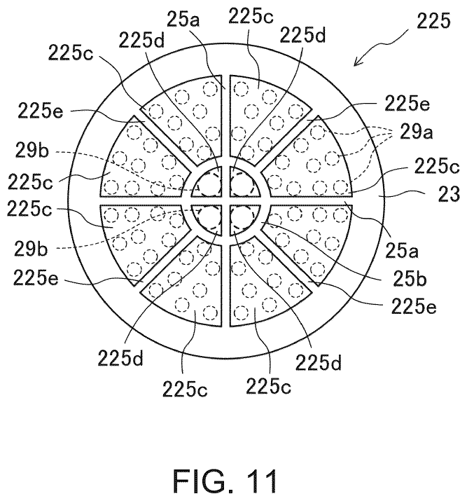

FIG. 11 illustrates Modification 2 of this embodiment. Modification 2 differs from the above embodiment in that third grids 225e are provided to a grid plate 225. Four third grids 225e are provided. The third grids 225e extend in the radial direction. The third grid 225e is located at the center of a pair of first grids 25a in the circumferential direction so that the first partitioned part 25c in the above embodiment is equally divided into two in the circumferential direction. The third grid 225e is integrally formed with the first body part 23 and the second grid 25b.

In Modification 2, since the third grids 225e are provided, the number of first partitioned parts 225c is eight in total. The area of the first partitioned part 225c of Modification 2 is substantially half of the area of the first partitioned part 25c in the above embodiment.

The area of the second partitioned part 225d is set so that the resonant frequency of the part of the vibration body 21 corresponding to a second partitioned part 225d does not become an integral multiple of the resonant frequency of the part of the vibration body 21 corresponding to the first partitioned part 225c. The area of the small bore 29a is set so that the resonant frequency of the part of the vibration body 21 corresponding to the small bore 29a does not become an integral multiple of the resonant frequencies of the parts of the vibration body 21 corresponding to the first partitioned part 225c and the second partitioned parts 225d.

Also in this Modification 2, the intake noise is amplified by the vibration body 21 vibrating by resonance with the intake pulse from the low frequency to the high frequency. Therefore, the frequency range over which the intake noise is amplified can be expanded.

### OTHER EMBODIMENTS

The art disclosed herein is not limited to the above embodiment, and it may be substituted without departing from the scope of the appended claims.

In the above embodiment, the grid plate 25 is provided to the first case 22, and the bore plate 29 is provided to the second case 26. Alternatively, the bore plate may be provided to the first case 22, and the grid plate may be provided to the second case 26.

Although in the above embodiment the first grid 25a and the second grid 25b are embedded in the vibration body 21, the first grid 25a and the second grid 25b may not be embedded in the vibration body 21, as long as they contact the vibration body 21.

The above-described embodiment is merely illustrative, and must not be used to interpret the scope of the present disclosure restrictively. The scope of the present disclosure is defined by the appended claims, and any modifications and changes which belong to the equivalents of the appended claims all fall within the present disclosure.

### INDUSTRIAL APPLICABILITY

The art disclosed herein is useful as the intake noise amplifying system of the internal combustion engine.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### DESCRIPTION OF REFERENCE CHARACTERS

1 Internal Combustion Engine
2 Intake Passage
10 Branch Pipe
21 Vibration Body
22 First Case
25 Grid Plate
25a First Grid
25b Second Grid
25c First Partitioned Part
25d Second Partitioned Part
26 Second Case
29 Bore Plate
29a Small Bore
125 Grid Plate
125b Second Grid
125c First Partitioned Part
125d Second Partitioned Part
225 Grid Plate
225a First Grid
225b Second Grid
225c First Partitioned Part
225d Second Partitioned Part
225e Third Grid
R Cabin
V Vehicle

What is claimed is:

1. An intake noise amplifying system of an internal combustion engine mounted on a vehicle, the intake noise amplifying system being provided to a branch pipe that branches from an intake passage of the internal combustion engine and transmits intake noise into a cabin of the vehicle, the intake noise amplifying system comprising:
a plate-shaped vibration body configured to vibrate by intake pulse from the intake passage;
a first case disposed at a part of the branch pipe on an intake passage side of the vibration body; and
a second case disposed at a part of the branch pipe on a cabin side of the vibration body,
wherein the vibration body is sandwiched between the first case and the second case,
wherein one of the first case and the second case includes a grid plate having a grid dividing the vibration body into a plurality of partitioned parts when the vibration body is seen in a direction perpendicular to the grid surface, and
wherein the other of the first case and the second case includes a bore plate having a plurality of bores each having an area smaller than a minimum area of the partitioned parts when the vibration body is seen in the direction perpendicular to the grid surface.

2. The intake noise amplifying system of claim 1, wherein the grid plate is provided to the first case, and the bore plate is provided to the second case.

3. The intake noise amplifying system of claim 2, wherein a number of bores of the bore plate is greater than a number of partitions of the grid plate.

4. The intake noise amplifying system of claim 2,
wherein the partitioned parts include a first partitioned part having a relatively large area, and a second partitioned part having a relatively small area, and
wherein the area of the bores is smaller than the area of the second partitioned part.

5. The intake noise amplifying system of claim 3, wherein the vibration body is made of rubber.

6. The intake noise amplifying system of claim 1, wherein a number of bores of the bore plate is more than a number of partitions of the grid plate.

7. The intake noise amplifying system of claim 6,
wherein the partitioned parts include a first partitioned part having a relatively large area, and a second partitioned part having a relatively small area, and
wherein the area of the bores is less than the area of the second partitioned part.

8. The intake noise amplifying system of claim 7, wherein the vibration body is made of rubber.

9. The intake noise amplifying system of claim 1,
wherein the partitioned parts include a first partitioned part having a relatively large area, and a second partitioned part having a relatively small area, and
wherein the area of the bores is less than the area of the second partitioned part.

10. The intake noise amplifying system of claim 9, wherein the vibration body is made of rubber.

11. The intake noise amplifying system of claim 1, wherein the vibration body is made of rubber.
